(19) United States
(12) Patent Application Publication
(10) Pub. No.: US 2007/0148508 A1
(43) Pub. Date: Jun. 28, 2007

(54) Reactor purge system and method

(76) Inventors: Peter Rezac, Marlborough, MA (US); Oren Bernstein, Swampscott, MA (US); Jeff Baldic, Milford, MA (US); Richard M. Mohring, East Brunswick, NJ (US); William Skrivan, Boston, MA (US); Ronald Rezac, Bolton, MA (US)

Correspondence Address: DICKSTEIN SHAPIRO LLP, 1825 EYE STREET NW, Washington, DC, 20006-5403, US

(21) Appl. No.: 11/598,091

(22) Filed: Nov. 13, 2006

Related U.S. Application Data
(60) Provisional application No. 60/735,212, filed on Nov. 10, 2005.

(51) Int. Cl. H01M 8/06; B01J 19/00

(52) U.S. Cl. 429/19; 429/34; 422/129

(57) ABSTRACT

Purge systems and methods are disclosed for flushing unreacted materials and byproducts from a reactor. In one embodiment, the reactor houses a hydrogen generation catalyst and the system comprises a hydrogen generation fuel cartridge containing a reservoir that stores water which may be recovered from the exhaust of a fuel cell. The reservoir may comprise a flexible bladder or a piston-type configuration. Water is delivered from the reservoir to flush the reactor of any residual fuel and/or byproducts.

### CROSS-REFERENCE TO RELATED APPLICATION

This application claims the benefit of U.S. Provisional Application Ser. No. 60/735,212, filed Nov. 10, 2005, the entire disclosure of which is incorporated herein by reference.

### STATEMENT REGARDING FEDERALLY SPONSORED RESEARCH OR DEVELOPMENT

The United States Government has certain rights in this invention pursuant to Technology Investment Agreement Number FA8650-04-3-2411 between the United States Air Force and Protonex Technology Corporation.

### FIELD OF THE INVENTION

The invention relates to systems and methods for flushing products and/or unconverted reactants from a reactor. The invention also relates to hydrogen generation fuel cartridge modules which can be removably connected to fuel cell power modules.

### BACKGROUND OF THE INVENTION

Hydrogen is the fuel of choice for fuel cells; however, its widespread use is complicated by the difficulties in storing the gas. Many hydrogen carriers, including hydrocarbons, metal hydrides, and chemical hydrides are being considered as hydrogen storage and supply systems. In each case, specific systems need to be developed in order to release the hydrogen from its carrier, either by chemical reaction or physical desorption.

One advantage of fuel cell power systems over batteries is that the former can be readily refuelable, containing a “replaceable” fuel cartridge module, and a “permanent” power module. A hydrogen fuel cell for small applications needs to be compact, lightweight, and preferably operable in any orientation. A fuel cartridge module preferably has a high gravimetric hydrogen storage density. Additionally, it should be easy to control the system's hydrogen flow rate and pressure to match the operating demands of the fuel cell.

### BRIEF SUMMARY OF THE INVENTION

The present invention is directed to systems for flushing materials from a reactor and/or plumbing and conduit lines. The systems preferably comprise a reactor configured to facilitate at least one chemical reaction to produce a desired product and byproduct materials, a separator capable of separating at least one liquid product, and a reservoir configured to store the liquid product thus separated. The system further comprises a conduit for conveying the liquid product from the separator to the reservoir, and means for delivering the liquid from the reservoir to the reactor to flush residual materials, e.g., byproducts and uncoverted reactants, from the reactor.

In a particularly preferred embodiment, the invention provides fuel cell power systems, comprising a power module containing a fuel cell, a hydrogen generation reaction chamber, a separator capable of separating water from exhaust gases from the fuel cell, and a reservoir configured to store water separated from the exhaust gases. In this embodiment, the reservoir is in fluid communication with the reaction chamber to permit flushing of the reaction chamber with water from the reservoir. In another preferred embodiment, the invention provides fuel cell power systems, comprising a power module, a reaction chamber configured to generate hydrogen from a fuel, and a reservoir in communication with the reaction chamber. The reservoir is configured to store water. Both of these embodiments further provide means for activating delivery of the water to flush the reaction chamber upon a predetermined condition.

The present invention also is directed to fuel cartridge systems, which comprise a reaction chamber, a fuel storage module, and a fuel regulator. The fuel cartridge systems comprise a hydrogen generation auxiliary module capable of regulating the flow of fuel to the reaction chamber to generate hydrogen, and a purge reservoir in fluid communication with the reaction chamber. In accordance with a further embodiment, the invention provides hydrogen gas generation systems, which comprise a fuel storage chamber, a reaction chamber, a hydrogen separation area, a control system capable of regulating flow of fuel to the reaction chamber to generate hydrogen, a purge reservoir configured to store water, and a conduit configured to convey the water from the purge reservoir to flush the reaction chamber.

In accordance with yet further embodiments, the invention is directed to methods for flushing hydrogen generation systems. The methods include providing a fuel cartridge module attached to a fuel cell module, the fuel cartridge module comprising a reservoir in communication with a reaction chamber, the reservoir being configured to store at least one liquid. At least one chemical reaction is conducted in a reaction chamber with fuel from the fuel cartridge module to generate hydrogen gas. At least part of the liquid stored in the reservoir is provided to the reaction chamber to flush the reaction chamber before or after hydrogen gas generation. In another embodiment, methods are provided for flushing residual materials from hydrogen generation reactors, by providing a fuel solution in a reactor, the reactor comprising an inlet for receiving the fuel solution to generate hydrogen and at least one byproduct, removing the at least one byproduct from the reactor, recovering water from the hydrogen and storing the water in a storage area, and delivering at least part of the water from the storage area back to the reactor to flush the reactor of residual materials.

### BRIEF DESCRIPTION OF THE DRAWINGS

A complete understanding of the present invention may be obtained by reference to the accompanying drawings when considered in conjunction with the following detailed description, in which:

FIG. 1 is a schematic of an exemplary system for reactor flushing in accordance with one embodiment of the present invention; and

FIG. 2 is a diagram of a locking mechanism useful in a system for reactor flushing in accordance with the present invention, wherein FIGS. 2A and 2B represent various stages during the connection of a fuel cartridge and a power module.

### DETAILED DESCRIPTION OF THE INVENTION

Fuel cell power systems useful in embodiments of the present invention can be readily refuelable, and can contain a “replaceable” fuel cartridge, and a “permanent” power module. The power module may comprise the fuel cell module, specifically the fuel cell stack and related balance of plant components, and the elements in the power module may be intended to last the lifetime of the power production device. The fuel cartridge may be disposable or it may simply be refillable, and comprises fuel storage areas, hydrogen generation components, and the hydrogen generation system's “balance of plant” comprising fuel regulation and other controls. The elements of the hydrogen generation balance of plant may be present within one or more of the fuel cartridge, the fuel cell power module, or a balance of plant module. The fuel cartridge may comprise one or more functional modules that may be separable, for example, a balance of plant module removably connected to a fuel storage module.

Examples of fuel cartridges include but are not limited to those provided in U.S. patent application Ser. No. 10/359,104 entitled “Hydrogen Gas Generation System,” which is hereby incorporated herein by reference in its entirety. Such cartridges may generate hydrogen on an “as-needed” basis for use by a fuel cell by, for example, the chemical reaction between a chemical hydride and water to produce hydrogen gas and a metal salt.

Other hydrogen generation fuels suitable for inclusion in a fuel cartridge include the reformable fuels. As used herein, reformable fuels are generally any fuel material that can be converted to hydrogen via a chemical reaction in a reactor, and include, for example, hydrocarbons and chemical hydrides. Hydrocarbon fuels useful for fuel cartridge systems include, for example, methanol, ethanol, propane, butane, gasoline, and diesel fuel. Hydrocarbons generally undergo reaction with water to generate hydrogen gas and carbon oxides. Methanol is preferred for such systems in accordance with the present invention.

Chemical hydride fuels useful for fuel cartridge systems include the alkali and alkaline earth metal hydrides having the general formula MHₙ, wherein M is a cation selected from the group consisting of alkali metal cations, such as sodium, potassium or lithium, and alkaline earth metal cations, such as calcium, and n is equal to the charge of the cation; and boron hydride compounds.

Boron hydrides as used herein include, for example, boranes, polyhedral boranes, and anions of borohydrides or polyhedral boranes, such as those disclosed in co-pending U.S. patent application Ser. No. 10/741,199, entitled “Fuel Blends for Hydrogen Generators,” the disclosure of which is hereby incorporated herein by reference in its entirety. Suitable boron hydrides include, without intended limitation, the group of borohydride salts M(BH₄)ₙ, triborohydride salts M(B₃H₈)ₙ, decahydrodecaborate salts M₂(B₁₀H₁₀)ₙ, tridecahydrodecaborate salts M(B₁₀H₁₃)ₙ, dodecahydrododecaborate salts M₂(B₁₂H₁₂)ₙ, and octadecahydroicosaborate salts M₂(B₂₀H₁₈)ₙ, where M is a cation selected from the group consisting of alkali metal cations, alkaline earth metal cations, aluminum cation, zinc cation, and ammonium cation, and n is equal to the charge of the cation; neutral borane compounds, such as decaborane(14) (B₁₀H₁₄); ammonia borane compounds of formula NHₓBH_{y}, wherein x and y independently=1 to 4 and do not have to be the same, NHₓRBH_{y}, wherein x and y independently=1 to 4 and do not have to be the same, and R is a methyl or ethyl group, and formula NH₃B₃H₇. M is preferably sodium, potassium, lithium, or calcium. Examples of suitable metal hydrides, without intended limitation, include NaH, LiH, MgH₂, NaBH₄, LiBH₄, NH₄BH₄, and the like. These metal hydrides may be utilized in mixtures, but are preferably utilized individually.

Chemical hydrides may be used as a dispersion or emulsion in a nonaqueous solvent, for example, as commercially available mineral oil dispersions. Such mixtures may include additional dispersants, such as those disclosed in U.S. patent application Ser. No. 11/074,360, entitled “Storage, Generation, and Use of Hydrogen,” the disclosure of which is hereby incorporated herein by reference in its entirety. In particular, many of the boron hydride compounds are water soluble and stable in aqueous solution. A stabilizer, preferably a metal hydroxide, is typically added to aqueous solutions of borohydride compounds in water. A fuel solution suitable for use in the systems and methods of the present invention may comprise, for example, about 10% to 35% by wt. sodium borohydride and about 0.01 to 5% by weight sodium hydroxide as a stabilizer. A process for generating hydrogen from such a stabilized metal hydride solution is described in U.S. Pat. No. 6,534,033, entitled “A System for Hydrogen Generation,” the disclosure of which is hereby incorporated herein by reference in its entirety.

As an example of a reformable chemical hydride fuel, borohydrides react with water to produce hydrogen gas and a borate in accordance with Equation 1 where MBH₄ and MBO₂, respectively, represent an alkali metal borohydride and an alkali metal metaborate:
MBH₄+2H₂O→MBO₂+4H₂+heat Eqn. 1

Since two molecules of water are consumed for each borohydride molecule during the reaction, the product stream containing the borate salt is more concentrated than the borohydride fuel mixture, and the borate salt may solidify or crystallize if there is insufficient water to maintain the product salt in solution. Precipitation of the product salt in the catalyst chamber reduces the effectiveness of a flow system by causing partial or complete blocks within the reactor or conduit lines. Clogging can be minimized by a constant flow of fuel through the chamber, the use of a dilute fuel feed, by periodically flushing the reactor, or a combination of these approaches. The use of a separate stream of water to dilute a fuel concentration is taught in U.S. patent application Ser. No. 10/867,032 entitled “Catalytic Reactor for Hydrogen Generator Systems” and U.S. patent application Ser. No. 10/223,871 entitled “System for Hydrogen Generation,” the disclosures of which are incorporated by reference herein in their entirety.

In accordance with one embodiment of the present invention, a fuel cartridge comprises a system and method to store water, and passively purge a hydrogen generation reactor that uses a reformable fuel to generate hydrogen. In some aspects, the water may be recovered from the exhaust of a fuel cell. A fuel cell produces electricity through the reactions shown in the Equations 2a, 2b, and 2c.
Anode: 2H₂→4H⁺+4e⁻ Eqn. 2a
Cathode: O₂+4H⁺+4e⁻→2H₂O Eqn. 2b
Net Reaction: 2H₂+O₂→2H₂O Eqn. 2c
During operation of a fuel cell, water produced at the cathode compartment of the fuel cell can accumulate. Water can also migrate to the anode. Water is periodically or continuously purged from the cathode; water may also be periodically purged from the anode. Any suitable separator can be used to isolate the water from the exhaust gases from the fuel cell purge cycles.

In other embodiments, the water may be present within the cartridge when the user obtains the cartridge or fuel cell power system and is not obtained from the fuel cell. In still other aspects, the water used may be water condensed from the hydrogen gas stream produced by the reformable fuel, such as by the reaction shown in Equation 1. A separator such as a condenser or heat exchanger in communication with the hydrogen gas stream may be used to condense liquid water from the hydrogen gas.

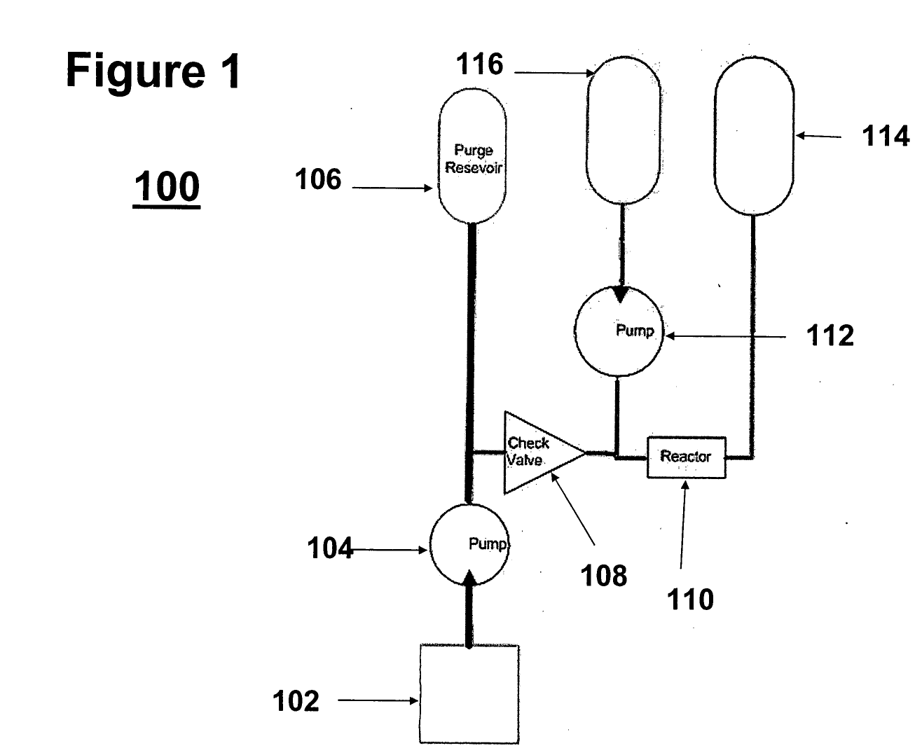

Referring to FIG. 1, an exemplary embodiment of a reactor flush system 100 according to the present invention comprises separator means 102, pump 104, reservoir 106, check valve 108, reactor 110, pump 112, fuel storage region 116 and product storage region 114. The individual components may all be contained with a fuel cartridge module or some components may be contained within the fuel cell power module. For boron hydride and hydrocarbon based fuel systems, reactor 110 preferably contains a catalyst system comprising a metal supported on a substrate. Structured catalyst supports such as honeycomb monoliths or metal foams may be used to obtain a desired plug flow pattern and mass transfer of the fuel to the catalyst surface. The catalyst may be in forms of beads, rings, pellets or chips, for example.

The preparation of such supported catalysts useful for boron hydride systems is taught, for example, in U.S. Pat. No. 6,534,033 entitled “System for Hydrogen Generation,” the disclosure of which is incorporated herein by reference. Suitable transition metal catalysts for the generation of hydrogen from a boron hydride solution include metals from Group IB to Group VIIIB of the Periodic Table, either utilized individually or in mixtures, or as compounds of these metals; representative examples of these metals include, without intended limitation, transition metals represented by the copper group, zinc group, scandium group, titanium group, vanadium group, chromium group, manganese group, iron group, cobalt group and nickel group. Specific examples of useful catalyst metals include, without intended limitation, ruthenium, iron, cobalt, nickel, copper, manganese, rhodium, rhenium, platinum, palladium, and chromium, and mixtures thereof. Suitable carriers include (1) activated carbon, coke, or charcoal; (2) ceramics and refractory inorganic oxides such as titanium dioxide, zirconium oxide and cerium oxides; (3) metal foams, sintered metals and metal fibers or composite materials of nickel and titanium; and (4) perovskites with the general formula ABO₃, where A is a metallic atom with a valence of +2 and B is a metallic atom with a valence of +4.

Suitable supported catalysts for hydrocarbon systems include, for example, metals on metal oxides. Specific examples of useful catalyst metals include, without intended limitation, copper, zinc, palladium, platinum, and ruthenium, and specific examples of useful catalyst metal oxides include, without intended limitation, zinc oxide (ZrO), alumina (Al₂O₃), chromium oxide, and zirconia (ZrO₂).

The reactor may further comprise elements such as heat exchangers, liquid diffusers, and the like as disclosed, for example, in U.S. patent application Ser. No. 10/867,032 entitled “Catalytic Reactor for Hydrogen Generation Systems,” the disclosure of which is hereby incorporated by reference. Such elements may include, for example, (a) a heat exchanging element that preheats the fuel solution prior to its contact with the catalytic material in the reactor, (b) a membrane capable of operating at temperatures above 100° C. and which allows the hydrogen to exit the catalyst bed as it is produced in the reactor, and (c) a water injector to enable the use of concentrated fuel solutions or slurries by adding water from, for example, reservoir 106, directly to the reactor.

Upon an initiation signal, liquid, such as water recovered from a fuel cell exhaust or condensed from the hydrogen gas stream, is pumped from separator 102 via pump 104 and collected in reservoir 106. The separator may be any suitable device capable of separating water from other liquid or gaseous materials, and may include, for example, membranes such as porous PTFE membranes or tubes that allow a gas to pass though but retain liquids, wicking structures that adsorb liquid from a two phase flow, centrifugal separators, cyclones, and condensers. The signal may be provided based on user intervention, i.e., upon the user pushing a start button or similar on/off switch, or may be provided upon connection of a power module to a fuel cartridge through a mechanical or electrical signal, or from an electronic control signal from the fuel cell. Reservoir 106 can be any suitable container or area capable of holding water, but preferably comprises an elastomeric flexible bladder constrained in a rigid shell. The liquid accumulates in reservoir 116 and is maintained under a predetermined pressure, for instance, the inlet pressure of reactor 110. A check valve 108 may be present in the conduit line to prevent the backflow of fuel from pump 112.

It is desirable to use the highest possible fuel concentrations to maximize hydrogen storage density within the system. Where the concentration of the metal hydride in the fuel exceeds the maximum solubility of the particular salt utilized, the fuel will be in the form of a slurry or suspension. The water stream can mix with the fuel mixture from region 116 entering the reactor, and dilute the incoming fuel to a desired concentration.

When fuel pump 112 is turned off, fuel no longer flows through reactor 110 and hydrogen gas is no longer produced by the contact of fuel with the catalyst within reactor 110. At this point, if the remaining hydrogen within the cartridge is consumed or vented from the cartridge system, the pressure at the reactor inlet drops and the remaining water is expelled from reservoir 106 through reactor 110, flushing the reactor of any residual fuel and/or products. The expulsion of water from the reservoir is accompanied by contraction of the flexible bladder. The cartridge also may be configured to depressurize upon being disconnected from the power module, thereby initiating the water flush of the reactor by causing the pressure drop at the reactor inlet.

Preferably, the hydrogen generation process and liquid fuel flow to the reactor are regulated in accordance with the hydrogen demands of the fuel cell. The power module may comprise a hydrogen inlet configured to transport hydrogen from the reactor and the fuel cartridge to a fuel cell stack for conversion to power. The fuel cartridge module may be connected to the power module by, for example, the hydrogen outlet of the fuel cartridge and the hydrogen inlet of the power module; and/or the water outlet of the fuel cell and a water inlet of the fuel cartridge. The fuel cartridge module may further be connected to the power module by an electronic interface and/or an air interface. A latch may be incorporated to further attach the power module and fuel cartridge module.

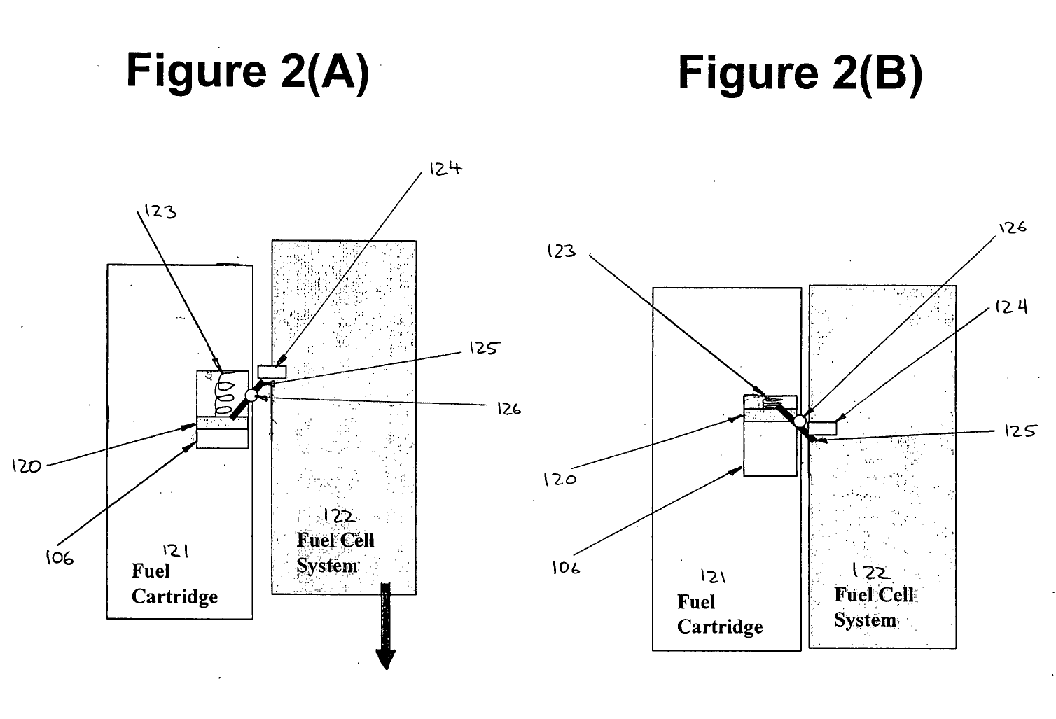

In another exemplary embodiment illustrated in FIGS. 2A and 2B, the pressure applied to reservoir 106 is from a bladder or piston structure 120 that is held in place by the physical act of inserting the cartridge 121 into the fuel cell power system 122. For example, as the user slides the cartridge 121 into place, a spring 123 within purge reservoir 106 within the cartridge can be compressed and held in place by a detent, latch or other physical barrier 124, creating a fixed volume reservoir rather than an expandable volume as in the elastomeric flexible bladder embodiment previously described. The physical barrier 124 may be automatically locked into place by the connection of the fuel cartridge 121 and power module 122, or, alternatively, a locking mechanism may be provided on either the fuel cartridge or power module to allow the operator to manually fix the barrier 124 in place.

Upon an initiation signal, water recovered from a fuel cell exhaust or condensed from the hydrogen gas stream is collected in reservoir 106 according to the teachings herein. When the physical barrier 124 holding the spring 123 in place is removed, the spring will expand and the reservoir 106 is compressed to drive the purge water through the catalyst reactor. The physical barrier may be removed, for example, by detaching the cartridge from the power module, or by the release of a locking mechanism by the operator. Alternatively, a lever arm 125, with associated fulcrum 126, may be attached to a motor which releases the locking mechanism in response to a control signal such as from the fuel cell. A system according to this embodiment also may be compressed, if desired, to a higher pressure than the system operating pressure, thereby facilitating delivery of the purge water at a higher rate to ensure complete flushing of the reactor.

In reference to the embodiments disclosed herein, one or both of pumps 104 and 112 may be selected from the group of, for example but not limited to, piezoelectric pumps, peristaltic pumps, piston pumps, and diaphragm pumps. For example, in one embodiment of a fuel cartridge system according to the present invention, one or both of pumps 104 and 112 may be present in the fuel cartridge module and may comprise piezoelectric pumps, wherein a piezoelectric crystal is present in a diaphragm that blocks a conduit line. Upon the application of an oscillating voltage to the piezoelectric crystal, a diaphragm pumps fluid through the conduit line. The power module may comprise electrical contacts on the interface between the fuel cartridge and the power module such that, when the fuel cartridge and power module are mated, the electrical contacts are in communication with the piezoelectric pump.

In other embodiments of fuel cartridge systems according the present invention, one or both of pumps 104 and 112 may comprise a separable pump, wherein a pump head resides in one of the fuel cartridge or fuel cell module and a controller resides in the other of the fuel cartridge or fuel cell module. The controller may comprise a motor or an electrical contact. In general, peristaltic and piston pumps operate through the use of a pump head comprised of a series of fingers in a linear or circular configuration or at least one piston which can compress the fuel line. The fingers may have a variety of configurations and alternatively are referred to as rollers, shoes, or wipers. The compression of the fuel line by the fingers forces the liquid through the line. When the line is not compressed and open, fluid flows into the fuel line.

A diaphragm pump configuration comprises a diaphragm in the wall of fuel line, check valves on the upstream and downstream sides of the diaphragm, and a pump head. Diaphragm pumps operate through the use of a pump head comprised of a series of cams in a linear or circular configuration or at least one piston which can compress the diaphragm. The compression of the diaphragm membrane by the fingers forces the liquid through the line. When the diaphragm membrane expands and is not compressed, fluid is drawn into the fuel line. The cams may have a variety of configurations and alternatively are referred to as rollers, shoes, or wipers. The check valves constrain and control the directional flow through the diaphragm and fuel line.

While the present invention has been described with respect to particular disclosed embodiments in respect to a fuel cartridge for a fuel cell using water reclaimed from a fuel cell or condensed from the hydrogen gas stream from a hydrogen generation reaction, it should be understood that numerous other embodiments are within the scope of the present invention. For example, water from any source or other reactor flushing liquids; solvents; antifreeze agents including methanol, propylene glycol, and ethylene glycol; acids; transition metal solutions; or other materials; and a user refillable tank, may be used within the scope of the invention. Further, the methods and systems of the invention are not limited to use within fuel cartridges, and may be incorporated to flush any reactor, preferably any reaction chamber that contains a catalyst to generate a product from a reagent stream. The flushing systems and methods of the present invention can thus be used to remove products and/or unconverted reactants or other residual materials from any reactor.

The above description and drawings illustrate preferred embodiments which achieve objects, features and advantages of the present invention. It is not intended that the present invention be limited to the illustrated embodiments. Any modification of the present invention which comes within the spirit and scope of the following claims should be considered part of the present invention.

What is claimed as new and desired to be protected by Letters Patent of the United States is:

1. A system for flushing materials from a reaction chamber, comprising:
a reaction chamber configured to facilitate at least one chemical reaction;
a separator capable of separating at least one liquid from a product of the reaction;
a reservoir configured to store the at least one liquid;
a conduit for conveying the liquid from the separator to the reservoir; and
means for delivering the liquid from the reservoir to the reaction chamber to flush materials from the reaction chamber.

2. The system of claim 1, wherein the means for delivery flushes residual reaction products from the reaction chamber.

3. The system of claim 1, wherein the means for delivery flushes unconverted reactants from the reaction chamber.

4. The system of claim 1, wherein the reservoir is a fixed-volume reservoir.

5. The system of claim 1, wherein the reservoir is a flexible bladder.

6. The system of claim 1, wherein the reservoir comprises an element configured to displace the liquid from the reservoir under pressure.

7. The system of claim 1, wherein the liquid is water.

8. The system of claim 1, wherein the liquid is water recovered from exhaust gases of a hydrogen consuming fuel cell.

9. The system of claim 1, wherein the liquid is water condensed from hydrogen output from a hydrogen generation reactor.

10. The catalytic system of claim 1, wherein the reservoir is part of a fuel cartridge module of a fuel cell power system.

11. A fuel cell power system, comprising:
a power module containing a fuel cell;
a hydrogen generation reaction chamber;
a separator capable of separating water from exhaust gases from the fuel cell; and
a reservoir configured to store water separated from the exhaust gases;
wherein the reservoir is in fluid communication with the reaction chamber to permit flushing of the reaction chamber with water from the reservoir.

12. The fuel cell power system of claim 11, wherein the power module is in communication with a fuel cartridge comprising a fuel storage area.

13. The fuel cell power system of claim 12, wherein the power module is removably attachable to the fuel cartridge.

14. The fuel cell power system of claim 13, wherein detaching the fuel cartridge activates flushing of the reaction chamber.

15. The fuel cell power system of claim 12, wherein the power module is connected to the fuel cartridge by at least one of an electronic interface or an air interface.

16. The fuel cell power system of claim 12, wherein the power module is connected to the fuel cartridge module by a hydrogen outlet of the fuel cartridge and a hydrogen inlet of the power module; and a water outlet of the fuel cell and a water inlet of the fuel cartridge.

17. The fuel cell power system of claim 12, wherein the fuel cartridge is disposable.

18. The fuel cell power system of claim 12, wherein the fuel cartridge comprises a refillable fuel storage area.

19. The fuel cell power system of claim 12, wherein the fuel storage area contains a hydrogen generating fuel.

20. The fuel cell power system of claim 19, wherein the hydrogen generating fuel is a reformable fuel.

21. The fuel cell power system of claim 19, wherein the hydrogen generating fuel comprises a material selected from the group consisting of hydrocarbons and chemical hydrides.

22. The fuel cell power system of claim 19, wherein the hydrogen generating fuel comprises a chemical hydride selected from the group consisting of boron hydrides and ionic hydride salts.

23. The fuel cell power system of claim 11, wherein the reaction chamber contains a supported catalyst capable of facilitating at least one chemical reaction that generates hydrogen.

24. The fuel cell power system of claim 23, further comprising means to condense water from hydrogen output from the at least one chemical reaction.

25. The fuel cell power system of claim 24, wherein the reservoir is in fluid communication with the means to condense water from hydrogen output from the at least one chemical reaction.

26. The fuel cell power system of claim 11, further comprising at least one pump configured to convey water from the separator to the reservoir.

27. The fuel cell power system of claim 26, wherein the at least one pump is selected from the group consisting of piezoelectric pumps, peristaltic pumps, piston pumps and diaphragm pumps.

28. The fuel cell power system of claim 11 further comprising a means for activating delivery of the water to flush the reaction chamber upon a predetermined condition.

29. A fuel cell power system, comprising:
a power module;
a hydrogen generation reaction chamber;
a separator capable of separating water from hydrogen produced by at least one chemical reaction that generates hydrogen from a fuel; and
a reservoir in communication with the reaction chamber, the reservoir being configured to store water; and
means for activating delivery of the water from the reservoir to flush the reaction chamber upon a predetermined condition.

30. The fuel cell power system of claim 29, wherein the power module is in communication with a fuel cartridge comprising a fuel storage area.

31. The fuel cell power system of claim 30, wherein the power module is removably attachable to the fuel cartridge.

32. The fuel cell power system of claim 31, wherein water is delivered to the reaction chamber upon detaching the fuel cartridge from the power module.

33. The fuel cell power system of claim 30, wherein the fuel storage area contains a hydrogen generating fuel.

34. The fuel cell power system of claim 33, wherein the hydrogen generating fuel is a reformable fuel.

35. The fuel cell power system of claim 33, wherein the hydrogen generating fuel comprises a material selected from the group consisting of hydrocarbons and chemical hydrides.

36. The fuel cell power system of claim 33, wherein the hydrogen generating fuel comprises a chemical hydride selected from the group consisting of boron hydrides and ionic hydride salts.

37. The fuel cell power system of claim 29, wherein the reaction chamber contains a supported catalyst capable of facilitating the at least one chemical reaction that generates hydrogen.

38. The fuel cell power system of claim 29, further comprising at least one pump configured to deliver the water to the reservoir.

39. The fuel cell power system of claim 38, wherein the at least one pump is selected from the group consisting of piezoelectric pumps, peristaltic pumps, piston pumps and diaphragm pumps.

40. A fuel cartridge system, comprising:
a reaction chamber configured to conduct at least one chemical reaction that generates hydrogen from a fuel;
a fuel storage area;
a fuel regulator;
a balance of plant module that contains a control system capable of regulating flow of fuel to the reaction chamber to generate hydrogen; and
a purge reservoir in fluid communication with the reaction chamber.

41. The fuel cartridge system of claim 40, wherein the fuel storage area is contained with a fuel storage module.

42. The fuel cartridge system of claim 41, wherein the balance of plant module is removably connected to the fuel storage module.

43. The fuel cartridge system of claim 41, wherein the reaction chamber is part of the fuel storage module.

44. The fuel cartridge system of claim 40, wherein the purge reservoir is in fluid communication with a separator means for separating water from hydrogen produced by the at least one chemical reaction or from fuel cell exhaust.

45. The fuel cartridge system of claim 40, wherein the purge reservoir contains water.

46. The fuel cartridge system of claim 40, wherein the purge reservoir comprises a flexible bladder.

47. The fuel cartridge system of claim 40, wherein the purge reservoir comprises a piston.

48. The fuel cartridge system of claim 40, wherein the fuel storage area contains a hydrogen generating fuel.

49. The fuel cartridge system of claim 48, wherein the hydrogen generating fuel comprises a reformable fuel.

50. The fuel cartridge system of claim 48, wherein the hydrogen generating fuel comprises a material selected from the group consisting of hydrocarbons and chemical hydrides.

51. The fuel cartridge system of claim 48, wherein the hydrogen generating fuel comprises a chemical hydride selected from the group consisting of boron hydrides and ionic hydride salts.

52. The fuel cartridge system of claim 40, wherein the reaction chamber contains a catalyst capable of facilitating the at least one chemical reaction that generates hydrogen.

53. The fuel cartridge system of claim 40, wherein the reaction chamber is part of the balance of plant module.

54. The fuel cartridge system of claim 40, wherein the fuel cartridge system further comprises a hydrogen outlet configured to deliver hydrogen gas to a hydrogen-consuming device.

55. A hydrogen gas generation system, comprising:
a fuel storage chamber;
a reaction chamber;
a hydrogen separation area;
a control system capable of regulating flow of fuel to the reaction chamber to generate hydrogen;
a purge reservoir configured to store liquid; and
a conduit configured to convey the liquid from the purge reservoir to flush the reaction chamber.

56. The system of claim 55, wherein the purge reservoir comprises a flexible bladder.

57. The system of claim 55, wherein the purge reservoir comprises a piston.

58. The system of claim 55, wherein at least one of the fuel chamber and the hydrogen separation area is bounded by a flexible wall.

59. The system of claim 55, wherein the fuel chamber is juxtaposed adjacent to the hydrogen separation area.

60. The system of claim 55, wherein the purge reservoir is a refillable tank.

61. The system of claim 55, further comprising a separator means for separating water from hydrogen produced in the reaction chamber.

62. The system of claim 61, further comprising a pump for conveying the water from the separator to the purge reservoir.

63. The system of claim 55, wherein the system is removably attachable to a fuel cell power module.

64. The system of claim 63, further comprising a separator means for separating water from a fuel cell electrode.

65. The system of claim 64, further comprising a pump for conveying the water from the separator to the purge reservoir.

66. The system of claim 63, further comprising a means for activating delivery of water to flush the reaction chamber when the system is removed from the power module.

67. The system of claim 55, wherein the fuel storage chamber is part of a fuel cartridge.

68. The system of claim 55, wherein the reaction chamber contains a supported catalyst capable of facilitating the generation of hydrogen.

69. The system of claim 55, wherein the system comprises a means for activating the flush of the reaction chamber by water from the purge reservoir.

70. A method for flushing a hydrogen generation system, comprising:
providing a fuel cartridge comprising a reservoir in communication with a reaction chamber, the reservoir being configured to store at least one liquid;
conducting at least one chemical reaction in the reaction chamber with fuel from the fuel cartridge to generate hydrogen gas; and
providing at least part of the liquid stored in the reservoir to the reaction chamber to flush the reaction chamber before or after hydrogen generation.

71. The method of claim 70, wherein the liquid is water.

72. The method of claim 70, wherein the liquid comprises methanol, ethylene glycol, or propylene glycol.

73. The method of claim 70, further comprising:
recovering water from hydrogen produced from the at least one chemical reaction or from fuel cell exhaust; and
storing the water in the reservoir.

74. The method of claim 73, further comprising pumping the water to the reservoir.

75. The method of claim 70, further comprising storing a hydrogen generating fuel within a fuel chamber.

76. The method of claim 75, wherein the hydrogen generating fuel is a reformable fuel.

77. The method of claim 75, wherein the hydrogen generating fuel comprises a material selected from the group consisting of hydrocarbons and chemical hydrides.

78. The method of claim 70, wherein the fuel cartridge further comprises:
a fuel storage area; and
a hydrogen separation area.

79. The method of claim 78, wherein the fuel storage and hydrogen separation areas are disposed in a volume exchange configuration.

80. The method of claim 78, further comprising diluting the fuel provided to the reaction chamber with at least part of the water.

81. The method of claim 78, further comprising flushing byproducts or unreacted materials from the reaction chamber by delivering the at least part of the water to the reaction chamber under pressure.

82. The method of claim 78, wherein the water is stored in a flexible bladder.

83. The method of claim 78, wherein the water is stored in a reservoir containing a piston configured to displace the water under pressure to flush the reaction chamber.
